(19) United States
(12) Patent Application Publication
(10) Pub. No.: US 2008/0234842 A1
(43) Pub. Date: Sep. 25, 2008

(54) MICROPHONES AS CONTACT SENSORS FOR DEVICE CONTROL

(75) Inventor: Zhengyou Zhang, Bellevue, WA (US)

Correspondence Address: MICROSOFT CORPORATION;C/O LYON & HARR, LLP, 300 ESPLANADE DRIVE, SUITE 800, OXNARD, CA, 93036, US

(73) Assignee: Microsoft Corporation, Redmond, WA (US)

(21) Appl. No.: 11/689,496

(22) Filed: Mar. 21, 2007

(51) Int. Cl. G05B 15/00

(52) U.S. Cl. 700/83

(57) ABSTRACT

A device controller that controls a device by tapping or rubbing the surface of microphones on the device. It allows microphones to be used as both speech sensors (to capture speech signals, the original functionality) and a device controller (the new functionality). Tapping or rubbing the surface of microphones on the device produces complex yet distinctive signals. By detecting these events, the present device controller can generate appropriate commands to control the device.

### BACKGROUND

Electronic devices in the consumer electronics arena are becoming smaller and smaller and more multi-functional. For example, a media player now can play video and audio. Some cellular phones can also be media players, can send and receive email, and can take photographs. Additionally, some of these multi-dimensional phones also have scheduling or calendaring applications embedded. The demand for such devices, as well as their functionality, is ever increasing.

Microphones are integrated into many such electronic devices, such as media players. Even if some media players do not have built-in microphones yet, they are expected to have them soon because the little additional cost in adding a microphone adds substantial value. First, when equipped with one or more microphones media players can also serve as a voice recorders. For example, one can record thoughts, interesting songs heard, shopping lists, and so on. Second, since more and more media players have wireless connections (Wi-Fi or Bluetooth, and eventually cellular modem), when they are near a wireless hotspot, with the added microphones, they become a VoIP endpoint, and can be used, for example, to make telephone calls over the Internet.

With the increasing functionality of electronic devices, real estate in and on these devices is becoming a valuable commodity. This is especially true because the users of these devices want them to be small and portable, not big and bulky. Thus, the size of the controls can impact the functionality of the device. For example, with the increasing popularity of video as an additional source of entertainment content, people want to have a larger screen with high definition on their media player. On one popular media playing device, the click-wheel which controls the device takes 50% of the space on the front of the player where the screen is. Other media players do better, but in one the button-ring controller still takes up 30% of the space on the front of the player, where the screen is. The size of the controls in these current media players, hence take up a large amount of space and therefore limit the size of the screens for viewing video.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The present device controller technique allows control of a device by tapping or rubbing the surface of one or more microphones on the device. It allows microphones to be used as both speech sensors (to capture speech signals, the original functionality) and a device controller (the new functionality, enabled by the present device controller technique). Tapping or rubbing the surface of microphones on the device produces complex yet distinctive signals. By detecting these events, the present device controller can generate appropriate commands to control the device. Thus, by using the microphones as device controllers valuable space is saved which can be used to impart other or improved functionality to the device.

It is noted that while the foregoing limitations in existing device control schemes described in the Background section can be resolved by a particular implementation of the present device controller technique, this is in no way limited to implementations that just solve any or all of the noted disadvantages. Rather, the present technique has a much wider application as will become evident from the descriptions to follow.

In the following description of embodiments of the present disclosure reference is made to the accompanying drawings which form a part hereof, and in which are shown, by way of illustration, specific embodiments in which the technique may be practiced. It is understood that other embodiments may be utilized and structural changes may be made without departing from the scope of the present disclosure.

### DESCRIPTION OF THE DRAWINGS

The specific features, aspects, and advantages of the disclosure will become better understood with regard to the following description, appended claims, and accompanying drawings where:

FIG. 1 is a diagram depicting a general purpose computing device constituting an exemplary system for a implementing a component of the present device controller technique.

FIG. 2 is a diagram depicting a controller module of one embodiment of a present device controller system.

FIG. 3 is a flow diagram depicting one exemplary embodiment of a process employing the present device controller technique.

FIG. 4 is a flow diagram depicting another exemplary embodiment of a process employing the present device controller technique.

FIG. 5 is a flow diagram depicting yet another exemplary embodiment of a process employing the present device controller technique.

FIG. 6 depicts exemplary waveforms generated by contact with two microphones of an electronic device.

FIG. 7 depicts an exemplary waveform of four taps to a microphone of an electronic device.

FIG. 8 is an example of an electronic media player that has four microphones to control the player, thus freeing up space on the device for a larger screen.

### DETAILED DESCRIPTION

### 1.0 The Computing Environment

Before providing a description of embodiments of the present device controller technique, a brief, general description of a suitable computing environment in which portions thereof may be implemented will be described. The present technique is operational with numerous general purpose or special purpose computing system environments or configurations. Examples of well known computing systems, environments, and/or configurations that may be suitable include, but are not limited to, personal computers, server computers, hand-held or laptop devices (for example, media players, notebook computers, cellular phones, personal data assistants, voice recorders), multiprocessor systems, microprocessor-based systems, set top boxes, programmable consumer electronics, network PCs, minicomputers, mainframe computers, distributed computing environments that include any of the above systems or devices, and the like.

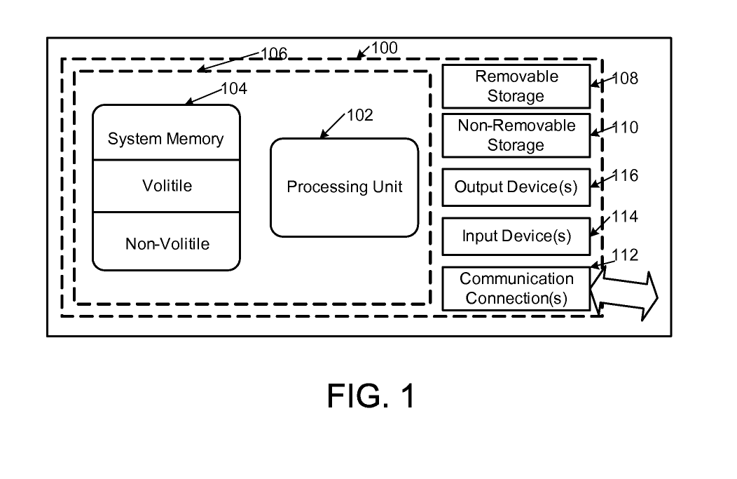

FIG. 1 illustrates an example of a suitable computing system environment. The computing system environment is only one example of a suitable computing environment and is not intended to suggest any limitation as to the scope of use or functionality of the present device controller technique. Neither should the computing environment be interpreted as having any dependency or requirement relating to any one or combination of components illustrated in the exemplary operating environment. With reference to FIG. 1, an exemplary system for implementing the present device controller technique includes a computing device, such as computing device 100. In its most basic configuration, computing device 100 typically includes at least one processing unit 102 and memory 104. Depending on the exact configuration and type of computing device, memory 104 may be volatile (such as RAM), non-volatile (such as ROM, flash memory, etc.) or some combination of the two. This most basic configuration is illustrated in FIG. 1 by dashed line 106. Additionally, device 100 may also have additional features/functionality. For example, device 100 may also include additional storage (removable and/or non-removable) including, but not limited to, magnetic or optical disks or tape. Such additional storage is illustrated in FIG. 1 by removable storage 108 and non-removable storage 110. Computer storage media includes volatile and nonvolatile, removable and non-removable media implemented in any method or technology for storage of information such as computer readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 100. Any such computer storage media may be part of device 100.

Device 100 has at least one microphone or similar sensor and may also contain communications connection(s) 112 that allow the device to communicate with other devices. Communications connection(s) 112 is an example of communication media. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

Device 100 may have various input device(s) 114 such as a keyboard, mouse, microphone, pen, touch input device, and so on. Output device(s) 116 such as a display, speakers, a printer, and so on may also be included. All of these devices are well known in the art and need not be discussed at length here.

Device 100 can include a camera as an input device 114 (such as a digital/electronic still or video camera, or film/photographic scanner), which is capable of capturing an image or a sequence of images, as an input device. Further, multiple cameras could be included as input devices. The images from the one or more cameras can be input into the device 100 via an appropriate interface (not shown). However, it is noted that image data can also be input into the device 100 from any computer-readable media as well, without requiring the use of a camera.

The present device controller technique may be described in the general context of computer-executable instructions, such as program modules, being executed by a computing device. Generally, program modules include routines, programs, objects, components, data structures, and so on, that perform particular tasks or implement particular abstract data types. The present device controller technique may also be practiced in distributed computing environments where tasks are performed by remote processing devices that are linked through a communications network. In a distributed computing environment, program modules may be located in both local and remote computer storage media including memory storage devices.

The exemplary operating environment having now been discussed, the remaining parts of this description section will be devoted to a description of the program modules embodying the present device controller technique.

### 2.0 Device Controller Technique

The present device controller controls a device by tapping or rubbing the surface of microphones on the device. It allows microphones to be used as both speech sensors (to capture speech signals, the original functionality) and device controller (the new functionality).

Tapping or rubbing the surface of microphones on the device produces complex yet distinctive signals. By detecting these events, the present device controller can generate appropriate commands to control the device.

2.1 Exemplary Architecture.

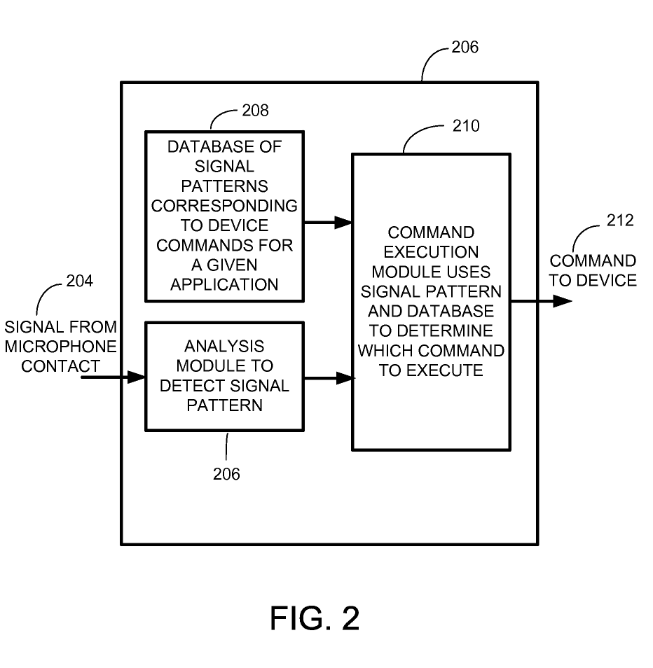

One exemplary architecture of the present device controller is shown in FIG. 2. A controller module 202 resides on an electronic or computing device such as, for example, a media player, camera phone, personal data assistant, voice recorder, or any other such device, such as was described with respect to FIG. 1. The controller module 202 includes a database of signal patterns 208 corresponding to device commands for a given application (for example, such an application could include recording, playback, electronic mail, camera, telephone, web browsing and so on). A signal 204 that is generated by directly touching one or more microphones on the device is input into the controller module 202. An analysis module 206 analyzes the input signal 204 to detect a signal pattern. A command execution module 210 then uses the signal pattern from the analysis module 206 and the database of signal patterns corresponding to device commands 208 for a given application to determine which command to execute. The chosen command 212 corresponding to the input signal 204 is then output to the device which uses it to control the device.

2.2 Exemplary Processes

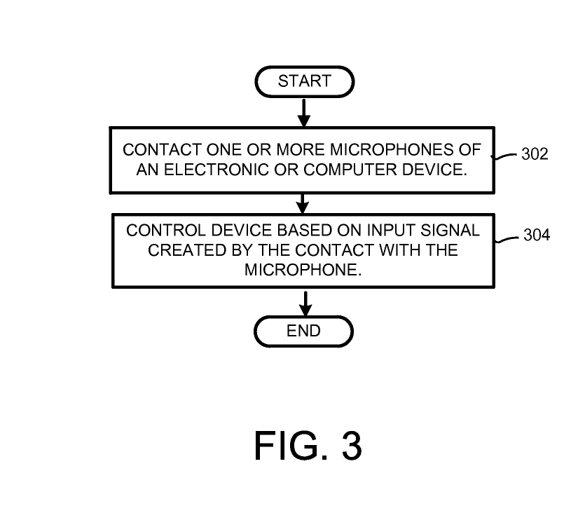

In the most general sense, one embodiment of a process employed by the present device controller process is shown in FIG. 3. In this embodiment, contact with one or more microphones embedded in an electronic or computing device is input (block 302). The device is then controlled based on the input signal created by the contact with the microphone (block 304).

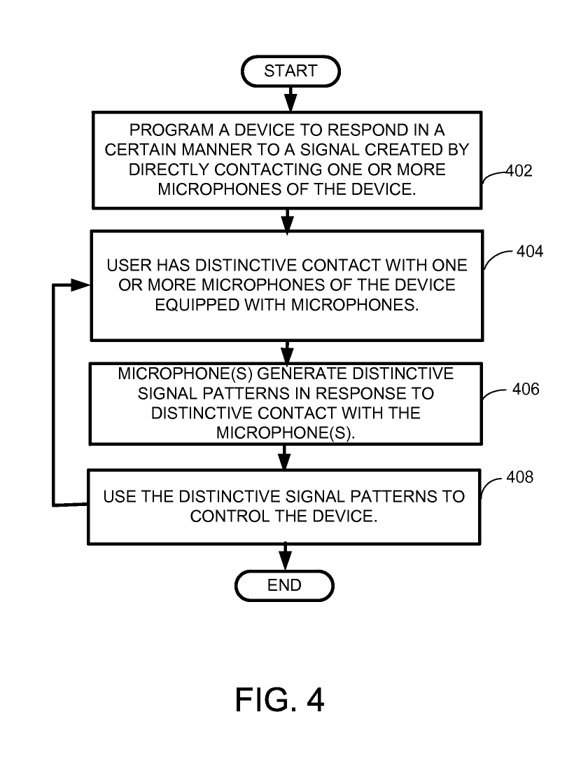

Another embodiment of a process employed by the present device controller technique is shown in FIG. 4. In this embodiment, a device is programmed to respond in a certain manner to a signal created by directly contacting one or more microphones of the device (block 402). A user of the device then has distinctive contact with one or more microphones of the device (block 404). The microphone or microphones generate distinctive signal patterns in response to the distinctive contact with the microphone or microphones (block 406). These distinctive signals or patterns are used to control the device by selecting the appropriate command that corresponds to the signal created by contact to the one or more microphones of the device (block 408). Exemplary commands, can include, for example, Start/Play, Stop, Pause, Resume, Next, Previous, Scroll down, Scroll up, and so on.

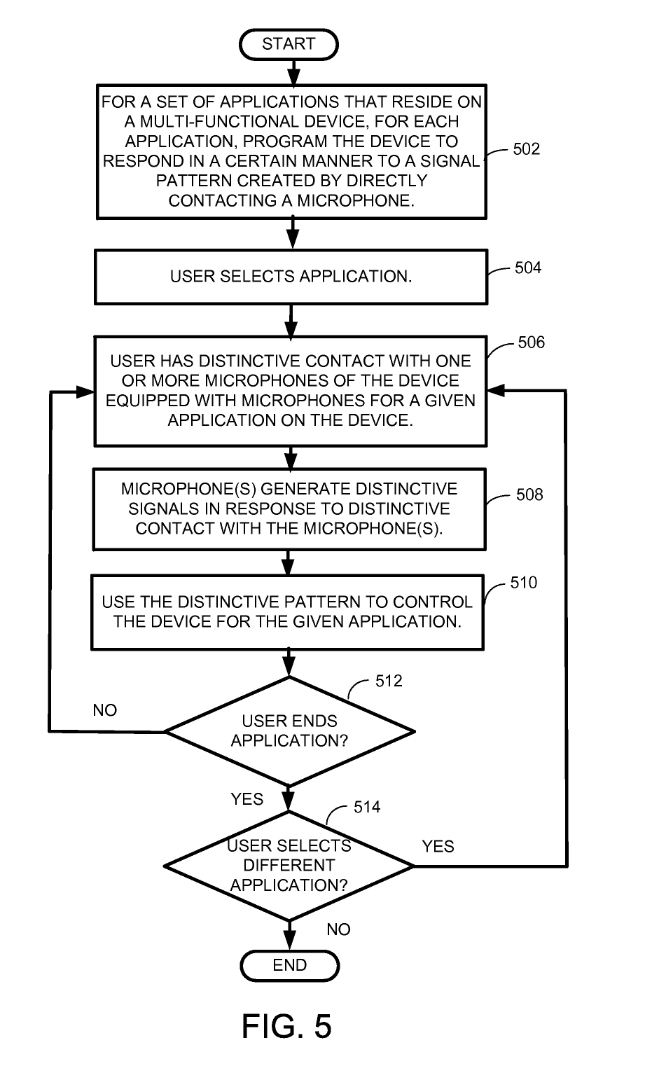

In yet another embodiment of the present device controller technique, the technique can use the same pattern to control various applications or functionality resident on the device. As shown in FIG. 5, for a set of applications that reside on a multi-functional device, for each application, the device is programmed to respond in a certain manner to a signal pattern created by directly contacting one or more microphones of the device (block 502). A user selects an application, such as, for example, a camera application, a music playback application or an emailing program (block 504). The user has distinctive contact with one or more microphones of the device (block 506). The microphone or microphones generate distinctive signals in response to this distinctive contact (block 508), which are used to control the device for the application presently in use (510). This continues until the user terminates the application (blocks 506 through 512). If the user selects a different application (block 514), the user again has distinctive contact with the microphone or microphones (506), the contact generates distinctive signals (block 508) and the distinctive signal pattern is used to control the device for the new application (510). It should be noted that the same contact pattern as was used to control the device in the first application can be used to indicate an entirely different set of commands to the device as for the second application.

2.3 Contact Patterns

Various patterns of contact with the microphone or microphones of the device can be used to control it. The following paragraphs describe some exemplary contacts and their use in controlling the device. While the following paragraphs describe some types of contacts that are possible in order to use one or more microphones to control a device, many other types of contact patterns are possible.

2.3.1 Tapping Contacts

In one embodiment, the number of possible contact patterns are determined by the number of microphones and sub-units of a unit of time in which the contact with the one or more microphones occurs. For example, if there is one microphone and four sub-units of a unit of time, there can be eight possible combinations of taps and pauses, and hence eight possible commands. The number of commands for a single microphone can be increased by increasing the length of time in which the contact pattern can be executed, but this then increases the time required to execute a command to the device.

An example is useful in clarifying the above description. For example, if one microphone is used, the device controller can use a scheme similar to Morse code to indicate various commands. Since the number of commands to control a device is limited, a scheme simpler than Morse code is enough. For example, in one exemplary embodiment, by using a combination of four sub-units of taps and pauses (where pause is delineated by the end of the sub-unit of time), the present device controller can have eight different commands for each task context. In this exemplary embodiment, each sub-unit takes about 20 milliseconds, so four sub-units take less than one second (allowing some variation). Below is a possible mapping (T=tap, p=pause) of using the microphone to generate commands to control the device by using a combination of taps and pauses.

T p p p→Start/Play

### T p p T→Stop

### T T T T→Pause

### T T p T→Resume

T p T p→Next
T T p p→Previous
T p T T→Scroll down
T T T p→Scroll up

In another exemplary embodiment, two microphones are used. With two units of time and two channels, this exemplary embodiment of the present device controller can generate six distinct commands. Below is a possible mapping (L=left tap, R=right tap, p=pause):

### L L→Play/Pause

### R R→Resume/Stop

### L R→Next

### R L→Previous

L p→Scroll up/Stop scroll
R p→Scroll down/Stop scroll

It should be noted that the above embodiments are provided as examples only. Many other combinations of patterns, units and subunits of time and numbers of microphones can be employed to control a device.

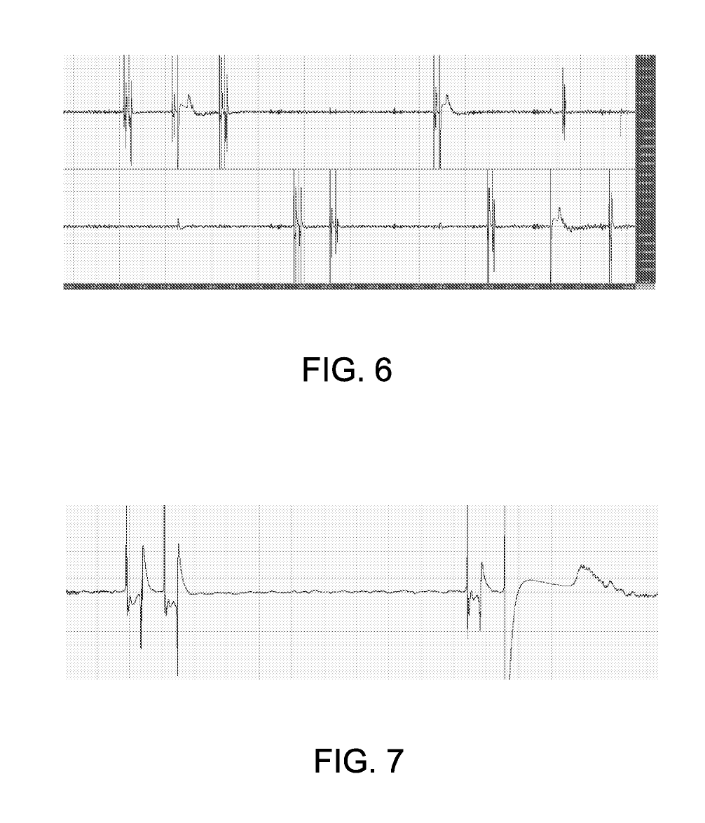

An example of two-channel signals with a speech background is shown in FIG. 6. The top trace depicts the left microphone channel of a two microphone device, while the bottom trace depicts the right microphone channel of the device. A zoom on a waveform of four taps is shown in FIG. 7. One can observe that a tap generates a sharp positive peak followed by a negative peak. This is a very distinctive and repeatable pattern. In one embodiment, the present device controller technique uses a simple match filter to detect this pattern. More sophisticated techniques such as, for example, learning-based feature detection can be used instead.

2.3.2 Rubbing Contacts

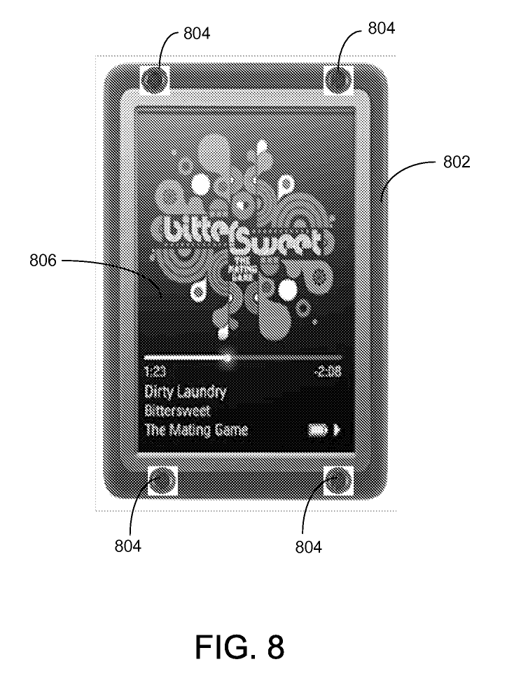

Besides using a pattern of taps and pauses to the microphone, the contact can also be rubbing the surface from one microphone to the surface of one or more other microphones. If there are four microphones 804 equally spaced around the periphery of an electronic device 802, as shown in FIG. 8, the sliding contact to the microphones can be used as a dial controller in controlling the computing device. This is advantageous in that it maximizes the use of the device space for a larger screen 806 or for other purposes.

### 3.0 Alternate Embodiments

It should also be noted that any or all of the aforementioned alternate embodiments may be used in any combination desired to form additional hybrid embodiments. Although the subject matter has been described in language specific to structural features and/or methodological acts, it is to be understood that the subject matter defined in the appended claims is not necessarily limited to the specific features or acts described above. For example, direct contact to other types of sensors, such as for example, light sensors, may be used to control a device in a similar manner. The specific features and acts described above are disclosed as example forms of implementing the claims.

Wherefore, what is claimed is:

1. A computer-implemented process for controlling an electronic device having a microphone, comprising:
directly contacting the surface of the microphone in a contact pattern;
using the contact pattern to control the electronic device.

2. The computer-implemented process of claim 1 wherein directly contacting the surface of a microphone comprises tapping on the surface of the microphone.

3. The computer-implemented process of claim 2 wherein the number of possible patterns is determined by the number of contacts in subunits of a time unit.

4. The computer-implemented process of claim 3 wherein the contact pattern corresponds to subunits of time and wherein each unit of time can be correlated to either a tap or a pause.

5. The computer-implemented process of claim 1 wherein each contact pattern corresponds to a different command to control the computing device.

6. The computer-implemented process of claim 1 wherein the same pattern can be used to control a different application on the electronic device.

7. The computer-implemented process of claim 6 wherein the application comprises at least one of:
a music player;
a voice recorder;
an electronic mail application;
a scheduling application;
a cellular phone application;
a notebook computer; or
a camera.

8. A computer-implemented process for controlling a computing device, comprising:
programming a computing device to respond in a certain manner in response to patterns of contacting the surface of one or more microphones of the device.

9. The computer-implemented process of claim 8, further comprising:
contacting the surface of the one or more microphones of a computing device in a distinctive contact pattern to which the one or more microphones generate a distinctive signal pattern; and
using the distinctive signal pattern to control the computing device.

10. The computer-implemented process of claim 8 wherein the possible contact patterns are determined by the number of microphones and subunits of a unit of time in which the contact with the one or more microphones occurs.

11. The computer-implemented process of claim 9 wherein the contact pattern comprises rubbing from surface of one microphone to the surface of one or more other microphones.

12. The computer-implemented process of claim 11 wherein there are four microphones and wherein the rubbing contact acts as a dial controller in controlling the computing device.

13. The computer-implemented process of claim 9 wherein the contact pattern comprises tapping the surface of the one or more microphones in a pattern of taps and pauses.

14. A computer-readable medium having computer-executable instructions for performing the process recited in claim 9.

15. A system for controlling an electronic device, comprising:
a general purpose computing device;
a computer program comprising program modules executable by the general purpose computing device, wherein the computing device is directed by the program modules of the computer program to,
create a database of commands corresponding to patterns of contact with a sensing device;
capture one or more patterns of contact with a sensing device;
match the captured patterns to select a command to control the electronic device; and
use the selected command to control the electronic device.

16. The system of claim 15 wherein the sensing device is a microphone.

17. The system of claim 15 wherein the sensing device is a light sensor.

18. The system of claim 15 wherein the electronic device is one of:
a music player,
a voice recorder,
a cellular phone,
a personal data assistant,
a notebook computer, or
a camera.

19. The system of claim 15 wherein the contact is one of:
a tapping of the surface of the sensor; and
a rubbing of the surface of the sensor.

20. The system of claim 15 comprising more than one sensing device.
